(19) United States
(12) Patent Application Publication
(10) Pub. No.: US 2025/0388028 A1
(43) Pub. Date: Dec. 25, 2025

(54) PRINTING SYSTEM AND PRINTING METHOD

(71) Applicant: NIDEC INSTRUMENTS CORPORATION, Nagano (JP)

(72) Inventor: Tomohiro HOSHI, Nagano (JP)

(21) Appl. No.: 19/241,374

(22) Filed: Jun. 18, 2025

(30) Foreign Application Priority Data
Jun. 20, 2024 (JP) 2024-099624

(51) Int. Cl. B41J 2/36; G06K 15/02

(52) U.S. Cl. CPC B41J 2/362; G06K 15/028; G06K 15/1878; G06K 15/1894; G06K 2215/0094

(57) ABSTRACT

A printing system including a printing device and a higher-level device to transmit image data to the printing device, wherein the higher-level device includes a correction value calculation portion to calculate a correction value for correcting the image data based on a density of each line of the image data, and a transmitter to add the correction value calculated by the correction value calculation portion to the image data for each line and transmit the image data and the correction value to the printing device, and wherein the printing device includes a storage unit to associate the correction value with the image data received from the higher-level device for each line and to store the image data and the correction value, and a printing unit to perform printing by changing a time for energizing each heating element in a thermal head based on the correction value stored in the storage unit.

### CROSS REFERENCE TO RELATED APPLICATION

The present invention claims priority under 35 U.S.C. § 119 to Japanese Application No. 2024-099624 filed Jun. 20, 2024, the entire content of which is incorporated herein by reference.

### BACKGROUND

### Field of the Invention

In particular, at least an embodiment of the present invention relates to a printing system and a printing method.

### Description of the Related Documents

There is a card issuing system that issues a card-shaped recording medium (hereinafter, simply referred to as a “card”).

In such a card issuing system, a card issuing device that issues a card is connected to a high-level device such as an automated teller machine (ATM). The card issuing device often includes a housing unit in which cards before being issued are stacked and housed, and a printing unit such as a printer that prints on the cards. The printing unit often performs thermal printing, such as sublimation or thermal transfer (melting type) printing, by heating an ink ribbon.

In a printing device that performs such thermal printing, a shortage of currents supplied to a thermal head may occur in an image area where many points to be energized are disposed on a single line. This current shortage may cause color unevenness.

Here, as a typical technique for improving color unevenness in conventional thermal printing, Japanese Unexamined Patent Application Publication No. 11-301004 describes a printing device that prints on a sheet by energizing a heating element corresponding to print data among a plurality of heating elements provided in a print head, the printing device including a correction value storage unit to store a correction value corresponding to an energy loss due to a voltage drop of each heating element, and an energization control unit to control an energization time for each heating element according to the correction value for the heating element stored in the correction value storage unit.

The technique according to Japanese Unexamined Patent Application Publication No. 11-301004 can suppress the density unevenness occurring in printing as described above.

However, in the related art as in Japanese Unexamined Patent Application Publication No. 11-301004, since the correction amount is calculated by the printing unit, a processing load is applied, and a printing time may be affected.

At least an embodiment of the present invention has been made in view of such circumstances, and its object is to provide a printing system capable of solving the above-described problems, suppressing color unevenness due to current shortage, and shortening a printing time.

### SUMMARY

A printing system according to at least an embodiment of the prevent invention includes a printing device and a higher-level device to transmit image data to the printing device, wherein the higher-level device includes a correction value calculation portion to calculate a correction value for correcting the image data based on a density of each line of the image data, and a transmitter to add the correction value calculated by the correction value calculation portion to the image data for each line and transmit the image data and the correction value to the printing device, and wherein the printing device includes a storage unit to associate the correction value with the image data received from the higher-level device for each line and to store the image data and the correction value, and a printing unit to perform printing by changing a time for energizing each heating element in a thermal head based on the correction value stored in the storage unit.

Such a configuration can suppress occurrence of color unevenness due to a current shortage and shorten a printing time.

In the printing system according to at least an embodiment of the present invention, the printing device receives the image data and the correction value at a timing for each line, or enables printing while receiving the image data and the correction value at a stage where the image data and the correction value are received halfway.

Such a configuration can shorten the printing time.

In the printing system according to at least an embodiment of the present invention, the correction value calculation portion calculates the correction value when the printing of the image data is instructed.

With such a configuration, an appropriate correction value can be calculated even if the image data changes during printing.

In the printing system according to at least an embodiment of the present invention, the correction value calculation portion analyzes the image data and adjusts the correction value according to the analysis result.

With such a configuration, color unevenness other than color unevenness for each line can also be improved.

In the printing system according to at least an embodiment of the present invention, the correction value calculation portion adjusts the correction value in consideration of a density of a preceding line and a density of a subsequent line.

Such a configuration can further reduce color unevenness for each line.

In the printing system according to at least an embodiment of the present invention, the correction value calculation portion adjusts the correction value for each color in a case where a color tone changes when all colors of each line are uniformly corrected.

Such a configuration can suppress a change in the color tone by uniformly correcting all colors.

In the printing system according to at least an embodiment of the present invention, the printing unit changes the time for energization by adjusting a strobe signal.

With such a configuration, finer adjustment can be performed.

A printing method according to at least an embodiment of the prevent invention is performed by a printing system including a printing device and a higher-level device to transmit image data to the printing device, wherein the higher-level device calculates a correction value for correcting the image data based on a density of each line of the image data, and the higher-level device adds the correction value to the image data for each line and transmits the image data and the correction value to the printing device, and wherein the printing device associates the correction value with the image data received from the higher-level device for each line and stores the image data and the correction value, and the printing device performs printing by changing a time for energizing each heating element in a thermal head based on the stored correction value. Such a configuration can suppress occurrence of color unevenness due to a current shortage and shorten a printing time.

According to at least an embodiment of the prevent invention, a printing system can be provided, wherein the higher-level device calculates a correction value for correcting the image data based on a density of each line of the image data, and adds the correction value to the image data for each line and transmits the image data and the correction value to the printing device, and wherein the printing device performs printing by changing a time for energizing each heating element in a thermal head based on the received correction value to suppress occurrence of color unevenness due to a current shortage and shorten a printing time.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a system configuration diagram of a card issuing system according to at least an embodiment of the present invention;

FIG. 2 is a conceptual diagram of the image data illustrated in FIG. 1;

FIG. 3 is a flowchart of a card issuing process according to at least an embodiment of the present invention; and

FIG. 4 is a photograph of a card printed with the card issuing process illustrated in FIG. 3.

### DETAILED DESCRIPTION

### Embodiment

### Configuration of Card Issuing System X

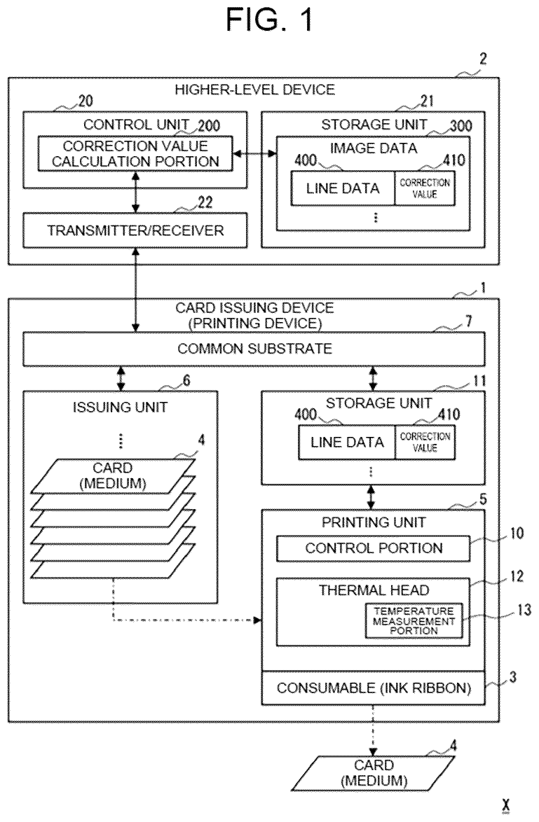

A configuration of a card issuing system X according to at least an embodiment of the present invention will be described with reference to FIG. 1. The card issuing system X according to the present embodiment is an example of a printing system that prints and issues a medium.

Specifically, the card issuing system X is a device to issue a new card 4 (medium). The card issuing system X includes, for example, an ATM having a card issuing function, a terminal of a kiosk, a ticket issuing system of a transportation, a point card issuing system of a convenience store or the like, a member card issuing system of a retail store, a card issuing and payment system of a game machine, an entrance/exit management system, a ticket issuing system of a vehicle, a management system of a parking lot, or the like (hereinafter, simply abbreviated as “ATM or the like”).

In the present embodiment, the card issuing system X includes a card issuing device 1 and a higher-level device 2. For example, the card issuing device 1 and the higher-level device 2 are connected by a universal serial bus (USB), an RS-232C, or the like (hereinafter, simply referred to as “USB or the like”).

The card issuing device 1 is an example of a printing device such as a print issuing printer or a card reader that prints necessary information on a card 4 and issues the card 4 according to an instruction from the higher-level device 2. In the present embodiment, communication between the card issuing device 1 and the higher-level device 2 is performed, for example, via USB or the like.

In the present embodiment, the higher-level device 2 is an information processing device to control the card issuing device 1 and achieve each functionality of an ATM or the like. Specifically, the higher-level device 2 is for example, a main body device of an ATM or the like and includes a control calculation device such as a personal computer (PC) for control, a tablet terminal, or a mobile phone. Therefore, the higher-level device 2 runs application software (Application Software, hereinafter simply referred to as ‘app’) to achieve functionalities of the card issuing system X.

In the present embodiment, the higher-level device 2 is connected to the card issuing device 1 to be controlled. In addition, the higher-level device 2 can be connected to a network, various peripheral devices, and the like.

The card 4 according to the present embodiment is an example of a media corresponding to a media issuing system of the present embodiment. The card 4 is, for example, a non-contact IC card, a contact IC card, and/or a magnetic card having a magnetic stripe. The card 4 may be, for example, a rectangular vinyl chloride card having a thickness of about 0.7 to 0.8 mm. When the card 4 is a magnetic card, for example, a magnetic stripe in which magnetic data is recorded is formed on the card 4. When the card 4 is a non-contact IC card and/or a contact IC card, for example, an IC chip is incorporated. Here, the card 4 may be provided with both the IC chip and the magnetic stripe. In addition, when the card 4 is a non-contact IC card, a read/write (R/W) antenna for short-range wireless communication may be incorporated. The card 4 may be a polyethylene terephthalate (PET) card having a thickness of about 0.18 to 0.36 mm, a paper card having a predetermined thickness, or the like.

The consumable 3 corresponding to the card issuing system X according to the present embodiment is, for example, an ink ribbon for a printing unit 5 to be described later. The ink ribbon may be, for example, a sublimation type or melting type ink ribbon to print in color or black-and-white on the card 4. Further, in the present embodiment, the ink ribbon may be an ink ribbon of three colors (complementary colors) including films of cyan (C), magenta (M), and yellow (Y) as a rule.

The color ink ribbon may further include a black (Key plate, K) dedicated ribbon. Further, in addition to these CMYK colors, an overcoat film to protect a printing surface may be included. In addition, the ink ribbon may include a special color (hereinafter, referred to as a “special color”) such as an anti-counterfeit color containing special metallic particles and the like, a metallic color, a fluorescent color, a hologram, or a thermally expandable film that expands due to heat. In the present embodiment, hereinafter, the overcoat and the special color may be referred to as “color”. In addition, the ink ribbon may include only black or other light colors. In addition, the ink ribbon of the consumable 3 includes a multi-time ink ribbon (which can be used a plurality of times).

An RFID tag (hereinafter, referred to as a “wireless tag”) of a communication system (ISO14443) similar to that of the non-contact IC card may be attached to the consumable 3, and consumable information including a type, an ID, a serial number, and the like of the consumable 3 may be managed.

### Control Configuration of Card Issuing Device 1

Next, a control configuration of the card issuing device 1 will be described. The card issuing device 1 includes a printing unit 5, an issuing unit 6, a common substrate 7, a storage unit 11, and the like.

The printing unit 5 is a card printer or the like that reads the line data 400 and correction value 410 and performs printing on the card 4. In the present embodiment, for example, the printing unit 5 performs printing by a sublimation type or melting type direct printing method using a thermal head 12 according to driving of a driving portion. For example, the printing unit 5 prints the card 4 discharged from the issuing unit 6 while transporting the card 4 along a transport path, and discharges the card 4 after printing. Thus, the printing unit 5 performs printing on the new card 4 by borderless, double-sided, black-and-white or color printing or the like by using the ink ribbon, photographic quality images and text can be printed on a surface of the card 4.

Specifically, the printing unit 5 includes, for example, a circuit and a mechanism of a print head such as the thermal head 12, and is capable of printing a full-color bitmap image such as image data 300 to be described later at several hundred dots per inch (dpi) or the like. In the present embodiment, pixels that can be printed at a time by the thermal head 12 in a diagonal direction of the printing direction are referred to as “one line”.

The issuing unit 6 is a hopper unit or the like in which a new card 4 before issuing is accommodated. The issuing unit 6 can discharge the accommodated card 4 to the printing unit 5 along an internal transport path under the control of the higher-level device 2.

The common substrate 7 is a device to connect the issuing unit 6 and the printing unit 5 to the higher-level device 2. In the present embodiment, the common substrate 7 includes, for example, a circuit and an interface on a substrate such as a USB provided on a substrate of the card issuing device 1. Specifically, the common substrate 7 can receive a command from the higher-level device 2 and respond to the command via a USB cable or the like. In addition, the common substrate 7 can store line data 400 and correction value 410 of image data 300 acquired from the higher-level device 2 in the storage unit 11 of the printing unit 5.

In addition, the common substrate 7 includes a control calculation unit and a circuit of a hub such as a USB, and connects the issuing unit 6 and the printing unit 5 via the USB hub.

The storage unit 11 is, for example, a non-transitory recording medium including a random access memory (RAM) and a read only memory (ROM). The ROM includes a flash memory and other non-volatile semiconductor memories. Furthermore, the ROM may be configured as a solid state drive (SSD) or an embedded multi media card (eMMC). The storage unit 11 stores various data including a control program and encrypted data for printing by the printing unit 5. The control program may include firmware of the card issuing device 1. The firmware may further include a binary of a program of a hardware description language (HDL) that configures FPGA.

The storage unit 11 may include a magnetic recording medium such as a hard disk drive (HDD), an optical recording medium such as an optical disc or a hologram recording medium, and other non-transitory recording media.

In the present embodiment, the storage unit 11 is connected to the common substrate 7 and the printing unit 5.

Next, the printing unit 5 will be described in more detail.

The printing unit 5 includes a control portion 10, the thermal head 12, and a temperature measurement portion 13.

The control portion 10 is a control calculation portion including a central processing unit (CPU), a micro processing unit (MPU), a field programmable gate array (FPGA), a graphics processing unit (GPU), a digital signal processor (DSP), an application specific integrated circuit (ASIC), and the like. Among these, the CPU, the MPU, and other components including the FPGA may be configured by different chips. The control portion 10 controls each unit of the card issuing device 1 according to a command received from the higher-level device 2. Specifically, the control portion 10 can control transport, printing, other issuing processes, and reading/writing processes of the card 4.

The thermal head 12 may be a heater array or the like which is an aggregate of heating elements to sublimate or melt ink contained in the ink ribbon of the consumable 3 and fixing the ink on the card 4. Therefore, the thermal head 12 can print a plurality of pixels at a time.

In the present embodiment, when the image data 300 for the card 4 to be described later is printed with 600×1000 pixels, the heating elements for one line, i.e., 600 pixels (dots) may be arranged on the thermal head 12. That is, the heating elements for one line may correspond to a length of a short side of the card 4, and printing can be performed at a time in the diagonal direction of the transport direction (printing direction) of the card 4. In this case, while transporting the card 4 in a long side direction (printing direction), the thermal head 12 energizes the heating elements corresponding to the respective pixels with the current in accordance with a timing to heat the ink ribbon, so that the image with 600×1000 pixels can be printed.

In the present embodiment, the thermal head 12 may include a temperature measurement portion 13.

The temperature measurement portion 13 may be a temperature sensor including a thermocouple (thermistor) to measure a temperature of the thermal head 12, an analog to digital (A/D) converter, and the like. The gradation value in printing is corrected by the measured temperature. In addition, the temperature measurement portion 13 may include, for example, a temperature sensor that measures the temperature inside the housing in a location other than the thermal head 12 of the printing unit 5.

The temperature measurement portion 13 measures the temperature of the thermal head 12 and/or the inside of the housing in response to an instruction (command) from the higher-level device 2, and transmits the measured temperature to the higher-level device 2 as temperature information. Further, the temperature measurement portion 13 may acquire the temperature for each specific color, for each line, or at a specific timing.

In addition, the printing unit 5 includes a driving portion that transports the card 4. The drive portion includes mechanisms such as a stepping motor, a roller, and an encoder that transport the card 4 in a transport path formed inside the card issuing device 1. Here, in the present embodiment, in the transport direction of the card 4 in the transport path, a side on which the card 4 is issued and discharged is referred to as a front direction (printing direction), and an inner side where the issuing unit 6 in which the card 4 is stored is referred to as a rear direction.

Further, the printing unit 5 may also have a functionality as a card reader capable of reading or writing the card 4 by being taken into the inside of the device by a motor driven by the driving portion. In this case, for example, the card issuing device 1 may be capable of performing read/write of the IC chip and read/write of the magnetic stripe. Further, the card issuing device 1 may include a card sensor such as an optical sensor or a switch to detect at which position in the transport path the card 4 exists.

### Control Configuration of Higher-Level Device 2

Next, a control configuration of the higher-level device 2 will be described.

The higher-level device 2 includes a control unit 20, a storage unit 21, a transmitter/receiver 22, and the like.

The control unit 20 is a control calculation unit including a CPU, an MPU, a GPU, a DSP, an ASIC, and the like.

The storage unit 21 is a recording medium including a RAM and a ROM. Among these, the ROM includes a flash memory and other nonvolatile semiconductor memories. Further, the storage unit 21 may include a magnetic recording medium such as a solid state drive (SSD) and a hard disk drive (HDD), an optical recording medium, and other non-transitory recording media such as an optical disk.

The storage unit 21 stores a control program to control the higher-level device 2. The control program includes an operating system (OS), a payment application, and a device driver to control the card issuing device 1. Among these, the device driver may include a program module such as a dynamic linking library (DLL) to perform USB communication with the card issuing device 1 and to transmit and receive commands and data.

The transmitter/receiver 22 is a circuit and a physical interface such as a chipset and an input/output (I/O) to connect to an external device. The transmitter/receiver 22 includes a general-purpose serial interface such as a USB for connecting to the card issuing device 1, a parallel interface, a digital video interface, and the like. Further, the transmitter/receiver 22 also includes a physical layer or the like of a network interface for connecting to a network.

In the present embodiment, an example in which the transmitter/receiver 22 is connected to the card issuing device 1 via a USB will be described. In addition, peripheral devices such as a display such as a liquid crystal display (LCD) panel or an organic EL panel provided in an ATM or the like, a touch panel, and various buttons may be connected to the transmitter/receiver 22.

### Functional Configuration of Card Issuing System X

Next, a functional configuration to print and issue the card 4 in the card issuing system X according to at least an embodiment of the present invention will be described.

The control unit 20 of the higher-level device 2 includes a correction value calculation portion 200.

The storage unit 21 of the higher-level device 2 stores the image data 300.

The storage unit 11 of the card issuing device 1 stores the line data 400 and the correction value 410.

The correction value calculation portion 200 calculates the correction value 410 for correcting the image data 300 based on a density of each line of the image data 300. The correction value calculation portion 200 separates the image data 300 according to each CMY color and generates the line data 400 for each line of the separated data. Then, the correction value calculation portion 200 calculates the correction value 410 based on a gradation value indicating brightness (density) of each pixel of the line data 400. Here, in the present embodiment, the correction value calculation portion 200 may calculate the correction value 410 when the printing of the image data 300 is instructed.

The correction value calculation portion 200 can analyze the image data 300 and change the correction value 410 according to the analysis result.

More specifically, the correction value calculation portion 200 can calculate the correction value 410 in consideration of a density of a preceding line and a density of a subsequent line.

Alternatively, the correction value 410 can be adjusted for each color in a case where a color tone changes when all colors of each line are uniformly corrected. In the present embodiment, the correction value 410 is adjusted for each CMY color.

Further, in the present embodiment, the correction value calculation portion 200 may be capable of generating the image data 300 itself to be printed when the card 4 is issued. In the present embodiment, the full-color image data 300 with 600×1000 pixels can be generated in accordance with a command or the like from an application for payment. At the time of generating this, the correction value calculation portion 200 may perform layout, resolution conversion, and the like.

In addition, the correction value calculation portion 200 executes, for example, an application such as an ATM that performs various payments and causes the card issuing device 1 to issue the card 4. That is, in the present embodiment, the correction value calculation portion 200 also functions as an execution portion of the application. In the present embodiment, in addition to the payments, the application can also interactively respond to the user and help design and issue the card 4.

Further, the correction value calculation portion 200 also executes a device driver, middleware, and the like to control the card issuing device 1. The device driver and the middleware may include a dynamic link library (DLL). Thus, the correction value calculation portion 200 transmits and receives a command and data associated with the command to and from the card issuing device 1.

In addition, the correction value calculation portion 200 transmits various commands and data at the time of payment or issuance of the card 4. In addition, the correction value calculation portion 200 can transmit a card read command to read information stored in the card 4, a card write command to write information in the card 4, and the like.

The transmitter/receiver 22 adds the correction value 410 calculated by the correction value calculation portion 200 to the image data 300 for each line and transmits the resultant data to the card issuing device 1. In the present embodiment, the transmitter/receiver 22 associates the line data 400 with the correction value 410, and transmits the line data 400 and the correction value 410 to the card issuing device 1.

The storage unit 11 associates the correction value 410 with the line data 400 of the image data 300 received from the higher-level device 2 for each line, and stores the line data 400 and the correction value 410. In the present embodiment, the line data 400 received via the common substrate 7 for each line can be associated with the correction value 410, and the line data 400 and the correction data 410 can be stored in the storage unit 11.

Based on the correction value 410 stored in the storage unit 11, the control portion 10 of the printing unit 5 performs printing while changing a time for energizing each heating element of the thermal head 12. At this time, in the present embodiment, the control portion 10 controls the density of the pixel by changing the energization time by adjusting a strobe signal. The strobe signal is a signal for instructing a timing of energization.

In the present embodiment, adjustment of the strobe signal may be adjustment of a delay time (hereinafter, referred to as a “timing”) until the start of energizing each heating element of the thermal head 12 and a length of the energization time (hereinafter, referred to as a “strobe length”). In this case, the control portion 10 sets the timing of the strobe signal and the strobe length according to the correction value 410. That is, the control portion 10 controls, for each of the plurality of heating elements, the timing and length of energization for the gradation value of each pixel of one line. Further, the control portion 10 can adjust the strobe signal based on a temperature measured by the temperature measurement portion 13.

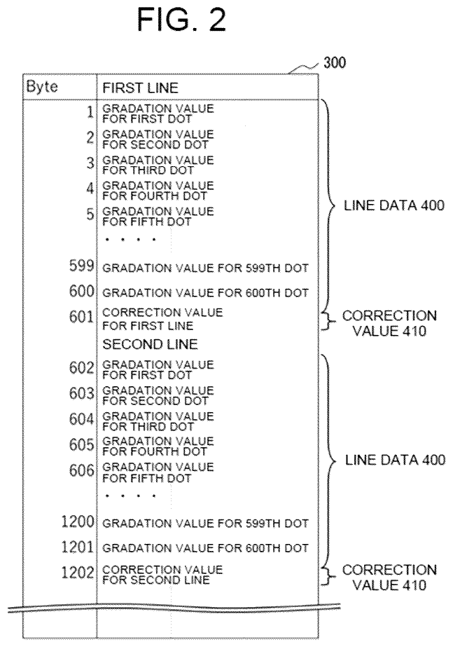

Next, the image data 300 will be described in detail with reference to FIG. 2. The image data 300 is an example of print data to be printed on the card 4 by the printing unit 5. In the present embodiment, an example will be described in which the image data 300 is data corresponding to printing of an area of the card 4, and is image data with 600 (in a diagonal direction of the printing direction)×1000 pixels (in a printing direction, that is, a transport direction of the card 4). Then, 600 pixels in the diagonal direction of the printing direction are referred to as “one line”. That is, “one line” is 600 dots (pixels) arranged in the diagonal direction of the printing direction which is the transport direction of the card 4, and corresponds to the number of pixels which can be printed at a time by the thermal head 12.

In the present embodiment, the image data 300 may be obtained by converting the CMY color bitmap data with 600×1000 pixels described above into the line data 400 for each color and adding the correction value 410 to the line data 400.

According to the example of FIG. 2, in the image data 300, as the line data 400 of the first line, a gradation value for a first dot (pixel), a gradation value for a second dot, . . . and a gradation value for a 600th dot corresponding to the first to 600th heating elements of one line are grouped together, forming the line data 400. The correction value 410 is added to the line data 400. Similarly, line data 400 and correction values 410 for a second to 1000th lines are prepared.

The correction value 410 is data for correcting a density value of the line data 400. In the present embodiment, the correction value 410 may be data indicating adjustment of the strobe value. Specifically, for example, a value of 8 bits (0 to 255) may be set as the correction value 410. Based on this value, the strobe value is changed. Accordingly, it is possible to express color density and gradation in color printing or monochrome printing.

In addition, the image data 300 may be, for example, primary colors of Red (R), Green (G), and Blue (B), or complementary colors of CMYK. Even in this case, the correction value 410 may be added to each of the line data 400 in the above-described format. In addition, the image data 300 may include data for the above-described special color. In addition, the image data 300 may be data in a Windows (R) BMP format, a TIFF format, a PNG format, or the like, and may not be compressed or may be compressed by run length, LZW, or the like.

Further, the bitmap data may be irreversibly compressed bitmap data such as a JPG format. In addition, the number of bits of each color of the image data 300 may be converted into, for example, the above-described 7-bit gradation value. Therefore, full color can be reproduced with 21 bits with 128 gradation values (7 bits)×3 for each color of CMY. In practice, a gradation value of a maximum density may be about “63” which is a half of 7 bits due to temperature correction or the like to be described later. Further, the image data 300 may be expressed by a 24 to 32-bit color bitmap by limiting the number of bits for K or a special color to about 4 bits even when CMY is 7 bits.

Alternatively, the image data 300 may be color data of 32 bits or more for the overcoat and other special colors. Further, depending on the specification of the printing unit 5, the data may be data of a gradation value with 8 bits (0 to 255), 16 bits (0 to 65536), or the like for each color. In addition, the gradation value may be a log scale, a gamma value, or the like, instead of a simple linear scale.

In addition, the image data 300 may include data such as a print feed speed, a temperature adjustment value, and an output gradation value as metadata or the like as setting values for appropriately printing according to the state of the consumable 3 for printing.

Further, the image data 300 is transmitted to the card issuing device 1 for each line by the correction value calculation portion 200 via the transmitter/receiver 22, and is stored in the storage unit 11 of the printing unit 5. At this time, the image data 300 may be stored in a RAM or a flash memory of the storage unit 11 of the printing unit 5.

Here, the control unit 20 of the higher-level device 2 is caused to function as the correction value calculation portion 200 by executing a control program stored in the storage unit 21.

Further, each unit of the higher-level device 2 and the card issuing device 1 described above is a hardware resource that executes a card reader control method according to the present embodiment.

A part or an arbitrary combination of the above-described functional configuration units may be configured as a circuit or hardware by an IC, a programmable logic, a field-programmable gate array (FPGA), or the like.

### Card Issuing Process by Card Issuing System X

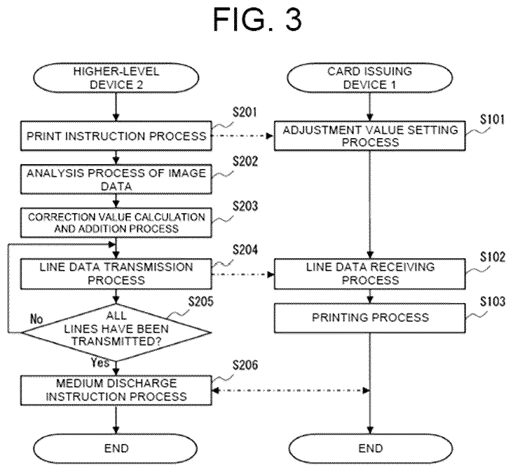

Next, a card issuing process by the card issuing system X according to at least an embodiment of the present invention will be described with reference to FIGS. 2 and 3. In the card issuing process according to the present embodiment, the higher-level device 2 executes an application such as an ATM. At this time, the higher-level device 2 calculates the line data 400 and the correction value 410 of the image data 300. The higher-level device 2 adds the correction value 410 to the line data 400, and transmits the line data 400 and the correction value 410 to the card issuing device 1. The card issuing device 1 associates the image data 300 for each line received from the higher-level device 2 with the correction value 410, and stores the image data 300 and the correction value 410. Then, based on the stored correction value 410, the time for energizing each heating element of the thermal head 12 is changed to print, thereby printing and issuing the card 4.

In the card issuing process according to the present embodiment, in the card issuing device 1, the control portion 10 of the printing unit 5 and a control portion of each unit execute a control program stored in the storage unit 11 or the like, and in the higher-level device 2, the control unit 20 executes a control program stored in the storage unit 21, in cooperation with each unit, using hardware resources.

Hereinafter, the card issuing process according to the present embodiment will be described in detail for each step with reference to the flowchart in FIG. 2.

### Step S201

First, the correction value calculation portion 200 of the higher-level device 2 performs a print instruction process.

Here, the correction value calculation portion 200 executes an application for card issuance and printing in an ATM or the like. This application may be executed in response to an instruction by the user, card payment by the card 4, issuance of a point card, or the like.

Next, the application receives an operation performed by the user on a touch panel, a numeric keypad, or the like, and generates original data that is data of an image serving as an original of the image data 300 for card issuance. Further, the application may cause a camera (not illustrated) to capture a face photo of the user operating the ATM or the like, and the face photo may be added to the original data.

The original data is transferred from the application to a DLL such as a device driver of the correction value calculation portion 200.

Then, according to the above-described example, the correction value calculation portion 200 generates the CMY color image data 300 of 600×1000 pixels. At this time, a resolution, a gradation, and the like may be changed from the original data in accordance with a format of the image data 300. At this time, the correction value calculation portion 200 may generate bitmap data for each of three colors of C, M, and Y.

Then, in the correction value calculation portion 200, the transmitter/receiver 22 transmits a print start command to the card issuing device 1.

### Step S101

Here, a process by the card issuing device 1 will be described.

When the print start command is acquired via the common substrate 7, the control portion 10 of the printing unit 5 performs an adjustment value setting process. In this process, the control portion 10 first calculates various adjustment values of a strobe value according to a temperature and other environmental values. This adjustment value is used for correction of the strobe value at the time of printing together with the correction value 410 for each line which will be described in detail later.

Specifically, for example, the control portion 10 causes the temperature measurement portion 13 to acquire a temperature correction value corresponding to the temperature of the thermal head 12 and a temperature in a housing of the printing unit 5.

In addition, the control portion 10 acquires a color balance adjustment value according to each color of CMY.

Further, the control portion 10 acquires an adjustment value corresponding to an entire voltage applied to the thermal head 12 as a voltage adjustment value.

The control portion 10 acquires head rank adjustment values corresponding to a usage period or aging degradation of the thermal head 12.

These various adjustment values may be preset and applied by being read from a table stored in the storage unit 11. Alternatively, these various adjustment values may be set by a preset correction formula.

In the present embodiment, these various adjustment values are uniformly set for each color, and are used for adjustment of the strobe value at the time of printing together with the correction value 410 to be described later.

### Step S202

The process by the higher-level device 2 will be described again. Here, the correction value calculation portion 200 performs analysis process of the image data 300. The correction value calculation portion 200 analyzes the image data 300 in a specific manner. For example, the correction value calculation portion 200 calculates a difference in density between the front and rear rows in the printing direction. Specifically, the correction value calculation portion 200 totals the gradation values in one line of the image data 300, calculates a difference from the total value for each line, and temporarily stores the difference in the storage unit 21 as difference value data. In addition, the correction value calculation portion 200 calculates a line in which a color tone changes when all colors of one line are uniformly corrected. This is also temporarily stored in the storage unit 21 as data for color tone adjustment. In addition, the correction value calculation portion 200 may generate statistical analysis data.

### Step S203

Next, the correction value calculation portion 200 performs a correction value calculation and addition process.

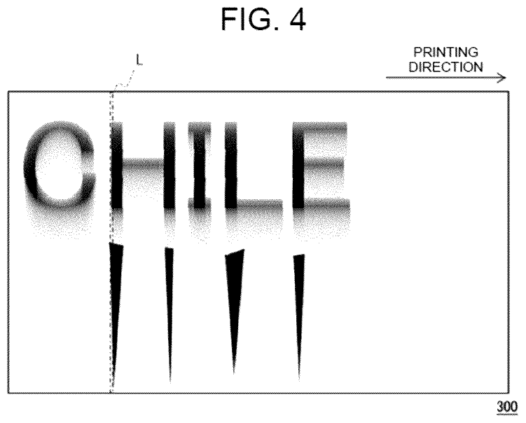

Referring to the example of FIG. 4, for example, in the image data, since the number of pixels to be drawn is larger in the portion of the line L than in the previous line, it is necessary to perform correction due to a voltage drop.

For this reason, in the present embodiment, the correction value calculation portion 200 calculates the total number of drawn pixels with the gradation value other than “0” in one line, calculates the amount of the voltage drop based on the total number of drawn pixels, and calculates the correction value 410 for correction with respect to the strobe value based on the amount of the voltage drop. More specifically, the correction value calculation portion 200 can calculate the correction value 410 based on a current applied to the thermal head 12. For example, the correction value calculation portion 200 can set the correction value 410 based on a value obtained by dividing a limit value of supply capability of the current to the thermal head 12 by a current value energized per heating element.

In the present embodiment, the correction for the strobe value is an adjustment value of an energization time for the thermal head 12 at the time of printing one line. Therefore, as the correction value 410, for example, a value corresponding to −15% to 0% of the energization time for one line can be set as a value such as 0 to 255 (one byte).

Here, in the card issuing device 1 according to the present embodiment, for example, a time of several ms is given to one line, and if the energization time during the several ms is longer, the color becomes darker, and if the time is shorter, the color becomes lighter.

For this reason, when the total number of drawn pixels is all pixels of one line, that is, 600 pixels in the present embodiment, no correction is performed, or when the total number of drawn pixels is one pixel, a value for correcting the energization time by −15% at the maximum can be set based on the set correction data. By setting the correction value 410 to reduce the maximum energization time in this way, it is possible to complete the process within the printing time for one line.

Here, the correction data for setting the correction value 410 may be a preset table in which the total number of pixels and the gradation value for the pixel after correction are associated with each other. Alternatively, the correction value calculation portion 200 may calculate the correction value 410 using the correction data and the preset correction formula. As a result, the density of the temperature value can be corrected with 7 bits (0 to 127 gradations) for each color described above.

Further, the correction value calculation portion 200 can also adjust the correction value 410 based on the above-described analysis result.

Specifically, the correction value calculation portion 200 adjusts the correction value 410 in consideration of a density of a preceding line and a density of a subsequent line. For example, the correction value calculation portion 200 may reduce the correction of the correction value 410 according to the difference value data for each line. That is, in this case, if the difference value data is larger, the ratio of reducing the energization time may be reduced. This is because there is a possibility that an instantaneous voltage drop of the voltage applied to the thermal head 12 can be compensated by a capacitor or the like on a circuit.

Therefore, the correction value calculation portion 200 can calculate the correction value 410 in consideration of a density of a preceding line and a density of a subsequent line.

Alternatively, the correction value calculation portion 200 adjusts the correction value 410 for each color in a line where the color tone changes when all colors of one line are uniformly corrected.

Specifically, the correction value calculation portion 200 can adjust the correction value 410 based on the color tone adjustment data so as to bring the color tone close to the same color tone. For example, the correction value calculation portion 200 may bring the correction value 410 close to the same value by a specific ratio in a line in which the correction value 410 is larger for any color of CMY but the correction value 410 is smaller for any other color.

Further, the correction value calculation portion 200 may adjust the correction value 410 according to other statistical analysis data.

The correction value calculation portion 200 may transmit a command for instructing the card issuing device 1 to transmit a temperature of the printing unit 5.

In addition, the correction value calculation portion 200 can acquire a temperature of the thermal head 12 and/or temperature information of the housing by the thermal head 12 and the temperature measurement portion 13 of the printing unit 5 in the card issuing device 1, thereby adjusting the correction value 410.

Here, the correction value calculation portion 200 adds the correction value 410 to line data 400 of each line in the image data 300. In the present embodiment, as illustrated in FIG. 2 described above, the correction value calculation portion 200 can add the correction value 410 with one byte to an end of the line data 400 of each line.

In the present embodiment, the correction value calculation portion 200 performs the same process from the second line to the 1000th line.

### Step S204

Here, the transmitter/receiver 22 performs a line data transmission process.

The transmitter/receiver 22 integrates the image data 300 to which the correction values 410 of all lines are added as one transmission command, and transmits the transmission command to the card issuing device 1 by the USB or the like via the DLL of the device driver or the like.

At this time, the transmitter/receiver 22 transmits the line data 400 and the correction value 410 thereof to the card issuing device 1 for each line.

### Step S102

Here, a process by the card issuing device 1 will be described again.

Here, the control portion 10 of the printing unit 5 performs a line data reception process. Specifically, the control unit of the common substrate 7 receives the line data 400 and the correction value 410 from the higher-level device 2. Accordingly, the control portion 10 of the printing unit 5 acquires the image data 300 received from the common substrate 7, and stores the image data 300 in the storage unit 11. Alternatively, the control unit of the common substrate 7 may directly store the line data 111 and the correction value 410 in the storage unit 11 of the printing unit 5 using a direct memory access (DMA) or the like.

That is, in the present embodiment, the card issuing device 1 can receive the line data 400 and the correction value 410 almost simultaneously at the timing for each line.

### Step S103

Next, the control portion 10 of the printing unit 5 performs a printing process.

In this process, the control portion 10 performs printing while changing the time of energizing each heating element of the thermal head 12 based on the correction value 410.

Specifically, the control portion 10 corrects the strobe value for each line using the above-described various adjustment values and the correction value 410.

In the present embodiment, the strobe value for energizing the heating element corresponding to each pixel is calculated by the following formula (1):

$$Strobe value = gradation value for pixel \times voltage adjustment value \times color balance adjustment value \times temperature adjustment value \times head rank adjustment value \times correction value 410 \qquad formula ( 1 )$$

In addition, when the energization is increased and the thermal head 12 warms up, since the same density is obtained by the energization of a short pulse, the control portion 10 may acquire the temperature information of the thermal head 12 from the temperature measurement portion 13 every one line to several tens of lines to adjust the strobe value. That is, when the temperature of the thermal head 12 is higher, the gradation value for each pixel may be adjusted to be decreased according to a specific adjustment curve. Regarding this adjustment, the control portion 10 may use a table or a correction formula included in the firmware of the storage unit 11, in which each temperature and the gradation value for the pixel after correction are associated with each other.

Here, the control portion 10 sets the calculated, adjusted, and corrected strobe value in the FPGA, and energizes each heating element of the thermal head 12 from the FPGA based on the strobe value. In this way, a time for applying heat to the thermal head 12 is changed.

That is, in the example described above, the control portion 10 drives the driving portion and the ink ribbon of the consumable 3 so that the printing unit 5 prints 600×1000 pixels for each line, and performs printing on the card 4 for each line based on the correction value 410. The control portion 10 repeats this for each color of CMY and prints all colors of the image data 300.

As a result, the control portion 10 can perform printing while receiving the image data 300 at the timing for each line. At this time, the control portion 10 can perform printing while receiving the image data 300 at the stage of receiving the image data 300 halfway. That is, it is also possible to perform printing while buffering.

### Step S205

The process by the higher-level device 2 will be described again.

The transmitter/receiver 22 determines whether or not all lines have been transmitted. When the transmitter/receiver 22 has finished transmitting the line data 400 and the correction values 410 in all image data 300 for each color of CMY, the transmitter/receiver 22 determines it as Yes. Otherwise, that is, when the transmitter/receiver 22 has not yet finished transmitting all the line data 400 and the correction value 410, the transmitter/receiver 22 determines it as No.

In the case of Yes, the transmitter/receiver 22 ends the card issuing process.

In the case of No, the transmitter/receiver 22 returns the process to step S204, and continues to transmit the line date 400 and the correction values 410.

### Step S206

When all lines have been transmitted, the transmitter/receiver 22 performs a medium discharge instruction process.

The transmitter/receiver 22 transmits the medium discharge command to the card issuing device 1.

The control portion 10 of the printing unit 5 of the card issuing device 1 activates the driving portion to transport the card 4 in the forward direction in the transport path and discharge the card 4. The control portion 10 of the printing unit 5 notifies the higher-level device 2 of a printing result through the common substrate 7.

Thereafter, the user operating the ATM or the like can acquire the printed card 4. Thus, the card issuing process according to at least an embodiment of the present invention is completed.

### Main Effects of Present Embodiment

With the above configuration, the following effects can be obtained.

In a conventional printing method, a voltage drop of a thermal head occurs depending on the content of an image, and color unevenness occurs. In order to improve the color unevenness, correction is required. However, when the correction is performed on the image itself in the printing apparatus, a processing load is applied, and an influence such as a delay in printing time may occur.

On the contrary, (1) a card issuing system X according to at least an embodiment of the prevent invention is a printing system that includes a card issuing device 1 being a printing device and a higher-level device 2 to transmit image data 300 to the card issuing device 1, wherein the higher-level device 2 includes a correction value calculation portion 200 to calculate a correction value 410 for correcting the image data 300 based on a density of each line of the image data 300, and a transmitter/receiver 22 functioning as a transmitter to add the correction value 410 calculated by the correction value calculation portion 200 to the image data 300 for each line and transmit the image data 300 and the correction value 410 to the card issuing device 1, and wherein the card issuing device 1 includes a storage unit 11 to associate the correction value 410 with the image data 300 received from the higher-level device 2 for each line and to store the image data 300 and the correction value 410, and a printing unit 5 to perform printing by changing a time for energizing each heating element in a thermal head 12 based on the correction value 410 stored in the storage unit 11.

With such a configuration, it is possible to improve the color unevenness due to the voltage drop and to shorten the printing time. That is, since the correction values 410 are calculated by the control unit 20 or the like of the higher-level device 2 having relatively higher performance than the control portion 10 of the card issuing device 1, the processing load can be suppressed as compared with the case where the correction values are calculated by the printing device, and the printing time can be shortened as compared with the related art. In addition, since it is not necessary to make a structural change such as an increase in printing performance of the printing unit 5, it is possible to perform high-quality printing while reducing the cost.

In addition, (2) the card issuing system X according to at least an embodiment of the present invention is the printing system according to (1), in which the line data 400 and the correction value 410 in the image data 300 are received at a timing for each line, or printing can be performed while receiving the line data 400 and the correction value 410 at a stage where the line data 400 and the correction value 410 are received halfway.

With this configuration, by receiving the line data 400 and the correction data at the same time, it is possible to perform printing while receiving the line data 400 and the correction data. Therefore, it is possible to shorten the printing time. Further, by buffering and printing the image data at a stage where the image data is received halfway, even if the transmission (reception) of the image data is delayed due to some reason when printing while receiving the image data, it is possible to suppress the possibility that the printing is temporarily stopped halfway.

(3) The card issuing system X according to at least an embodiment of the present invention is the printing system according to (1) or (2), wherein the correction value calculation portion 200 calculates the correction value 410 when printing of the image data 300 is instructed.

With this configuration, when a print instruction is received by the higher-level device 2, it is possible to calculate the correction value 410 corresponding to the image data 300 to be printed at that time. Therefore, even if the generated image data 300 is changed by the application, an appropriate correction value 410 can be calculated in accordance with the changed image data 300. That is, instead of the correction value 410 prepared in advance, the correction value 410 can be changed for each image data 300. In addition, although it takes a long time to calculate the correction value 410 by the printing unit 5 of the card issuing device 1, the issuing time can be shortened by calculating the correction value 410 by the higher-level device 2.

(4) The card issuing system X according to at least an embodiment of the present invention is the printing system according to any one of (1) to (3), wherein the correction value calculation portion 200 analyzes the image data 300 and adjusts the correction value 410 according to the analysis result.

With this configuration, by adjusting the correction value 410 according to the analysis result, color unevenness other than color unevenness due to a voltage drop for each line can also be improved. In addition, the color unevenness due to the voltage drop for each line can be adjusted more finely according to the analysis result.

(5) The card issuing system X according to at least an embodiment of the present invention is the printing system according to (4), wherein the correction value calculation portion 200 adjusts the correction value 410 in consideration of a density of a preceding line and a subsequent line.

With such a configuration, it is possible to predict the degree of the voltage drop according to the difference value data of the preceding line and the subsequent line, and to reduce the color unevenness for each line. Therefore, printing can be performed with higher quality.

(6) The card issuing system X according to at least an embodiment of the present invention is the printing system according to (4) or (5), wherein the correction value calculation portion 200 adjusts the correction value 410 for each color in a case where a color tone changes when all colors of one line are uniformly corrected.

Such a configuration can suppress a change in the color tone by uniformly correcting all colors. Therefore, printing can be performed with higher quality by suppressing overall color unevenness.

(7) The card issuing system X according to at least an embodiment of the present invention is the printing system according to any one of (1) to (6), wherein the printing unit 5 changes an energization time by adjusting the strobe signal.

With this configuration, it is possible to perform finer adjustment by correcting the strobe signal, compared to the case where the change is too large when the correction is performed on the image data 300 itself. Therefore, printing can be performed with higher quality.

(8) A printing method according to at least an embodiment of the present invention is a printing method executed by a printing system including a card issuing device 1 being a printing device and a higher-level device 2 to transmit image data 300 to the card issuing device 1, in which the higher-level device 2 calculates a correction value 410 for correcting the image data 300 based on a density of each line of the image data 300, and adds the correction value 410 to the image data 300 for each line and transmits the image data 300 and the correction value 410 to the card issuing device 1, the card issuing device 1 associates the correction value 410 with the image data 300 received from the higher-level device 2 for each line and stores the image data 300 and the correction value, and performs printing by changing a time for energizing each heating element of a thermal head 12 based on the stored correction value 410.

With this configuration, the processing load can be suppressed as compared with the case where the correction value is calculated by the printing unit, and the printing time can be shortened as compared with the related art.

### Other Embodiments

In the above-described embodiments, the example in which various adjustment values of the strobe value according to the temperature and other environmental values are calculated by the card issuing device 1 has been described.

However, all or some of these various adjustment values may be calculated by the higher-level device 2.

With such a configuration, it is possible to reduce the processing load of the card issuing device 1 and increase the printing speed.

In the above-described embodiment, the example is described in which the correction value 410 is calculated using the total number of pixels with the gradation value other than “0” in the line data 400.

However, the correction value 410 may be calculated more accurately by simply using a value such as the total of the gradation values or the total of the voltages to which the voltage is added according to the gradation value after the gamma correction or the like. Further, in the above-described embodiment, the example in which the correction value 410 is set as the correction value 410 such that the energization time is reduced by −15% has been described.

However, the amount by which the energization time is reduced may be more or less than −15%, or the energization time may be increased. In some cases, the voltage may be applied to the next pixel, or the timing at which the voltage is applied may be adjusted.

With such a configuration, it is possible to more reliably improve color unevenness and perform printing with high quality in accordance with the configuration of the thermal head 12 and other members.

In the above-described embodiment, the example in which the correction value 410 is adjusted by the difference value data has been described.

However, the correction value 410 may be more finely adjusted for each line by setting a followability, a capacity, and the like of a capacitor or a power source that accumulates electric power supplied to the thermal head 12.

With such a configuration, it is possible to more reliably suppress occurrence of color unevenness. In addition, it is easy to cope with suppression of occurrence of color unevenness due to the environment.

In the above-described embodiment, the example in which the image data 300 is bitmap data has been described.

However, the image data 300 may be data including a portable document format (PDF), a post script (PS), or other vector data. The correction value 410 may be generated directly from the vector data.

With such a configuration, it is possible to cope with data configurations of various formats.

In the above-described embodiment, the example in which printing is performed on the card 4 by a sublimation type or melting type printer mainly using an ink ribbon has been described.

However, even a printer using other printing methods, such as a thermal printer using heat-sensitive paper, an ink jet printer, a dot matrix printer, and a composite nozzle melting type 3D printer, can be used for a printing method using a head of a type in which a large current is applied to draw each pixel. For example, even in the case of an inkjet printer, color unevenness can be reduced by using the inkjet printer as a printer of a type in which air bubbles are generated in an ink conduit by heat.

Further, the printer may be a roll-paper printer instead of a single-sheet printer, or a monochrome printer instead of a color printer. Through these printing methods, the above-described density control methods can also be modified.

With such a configuration, it is possible to perform printing with color unevenness reduced on the card 4 corresponding to various configurations.

In the above-described embodiment, the example in which the higher-level device 2 is a main body such as an ATM has been described.

However, the higher-level device 2 may be a PC, a smartphone, or the like that designs the card 4. In this case, an application or the like that designs the card 4 may be installed in the PC, the smartphone, or the like, and may be connected to the printing unit 5 in a wired or wireless manner.

In addition, in the above-described embodiment, the example in which the image data 300 is transmitted from the higher-level device 2 to the card issuing device 1 directly connected thereto has been described.

However, it is also possible to adopt a configuration in which the line data 400 and the correction value 410 are encrypted with a symmetric key, a public key, or the like and then transmitted to the card issuing device 1 via a network. In this case, the correction value 410 may be used for decryption of CRC or key data.

With this configuration, it is possible to cope with various configurations. In addition, security can be improved by encryption.

The printing unit 5 of the card issuing device 1 may not be mounted on the card issuing device 1 and may be separately connected to the card issuing device 1 by a USB, a wireless connection, or the like. Alternatively, the card issuing device 1 may not be connected to the higher-level device 2 in the housing and may be connected to the higher-level device 2 such as a PC or a smartphone by a USB, a wireless connection, or the like. In this case, the storage unit 11 may be directly incorporated in the printing unit 5. Furthermore, a system on chip (SOC) or a multi-package in which the control portion 10 and the storage unit 11 are integrated may be used.

Further, the card issuing device 1 may be able to perform printing in a so-called “stand-alone” manner in which the card issuing device 1 is not connected to the higher-level device 2. In this case, the stand-alone card issuing device 1 may be capable of acquiring the line data 400 and the correction value 410 described above by being temporarily connected to the higher-level device 2, other terminals, a flash memory card, or the like.

In the above-described embodiment, the example in which the card 4 is printed and issued as an example of a medium has been described.

However, in addition to the card 4, for example, a parking ticket, an admission ticket, a ticket of a train, an airplane, or the like, other tickets, a label printed by a label printer, a receipt, a conductive ink printer such as a radio frequency identifier (RFID), and other media on which a code needs to be printed can be issued by the same configuration. With this configuration, it is possible to cope with various media.

Further, in the above-described embodiment, the configuration related to the issuance of the card 4 by the card issuing device 1 has been described mainly as the printing device. However, the card issuing device 1 may include a functionality of a card reader including a head or the like for reading information stored in the card 4. The head or the like includes, for example, a magnetic head, an encryption magnetic head, an IC contact, an electromagnetic induction antenna, and the like. The magnetic head, by making contact with and sliding over the card 4, can read and write magnetic information recorded on a magnetic stripe provided on the card 4. In an IC contact, an electromagnetic induction antenna, or the like, it is possible to read and write information stored in the IC incorporated in the card 4 through contact with a contact of the card 4 or via electromagnetic induction.

It should be noted that the configuration and operation of the above-described embodiment are merely examples, and it goes without saying that appropriate modifications can be made and implemented without departing from the spirit of the present invention.

What is claimed is:

1. A printing system comprising a printing device and a higher-level device to transmit image data to the printing device, wherein
the higher-level device comprises:
a correction value calculation portion to calculate a correction value for correcting the image data based on a density of each line of the image data, and
a transmitter to add the correction value calculated by the correction value calculation portion to the image data for each line and transmit the image data and the correction value to the printing device, and wherein
the printing device comprises:
a storage unit to associate the correction value with the image data received from the higher-level device for each line and to store the image data and the correction value, and
a printing unit to perform printing by changing a time for energizing each heating element in a thermal head based on the correction value stored in the storage unit.

2. The printing system according to claim 1, wherein
the printing device
receives the image data and the correction value at a timing for each line, or enables printing while receiving the image data and the correction value at a stage where the image data and the correction value are received halfway.

3. The printing system according to claim 1, wherein
the correction value calculation portion
calculates the correction value when the printing of the image data is instructed.

4. The printing system according to claim 1, wherein
the correction value calculation portion
analyzes the image data and adjusts the correction value according to the analysis result.

5. The printing system according to claim 4, wherein
the correction value calculation portion
adjusts the correction value in consideration of a density of a preceding line and a density of a subsequent line.

6. The printing system according to claim 4, the correction value calculation portion
adjusts the correction value for each color in a case where a color tone changes when all colors of each line are uniformly corrected.

7. The printing system according to claim 1, wherein
the printing unit changes the time for energization by adjusting a strobe signal.

8. A printing method performed by a printing system comprising a printing device and a higher-level device to transmit image data to the printing device, wherein
the higher-level device calculates a correction value for correcting the image data based on a density of each line of the image data, and
the higher-level device adds the correction value to the image data for each line and transmits the image data and the correction value to the printing device, and wherein
the printing device associates the correction value with the image data received from the higher-level device for each line and stores the image data and the correction value, and
the printing device performs printing by changing a time for energizing each heating element in a thermal head based on the stored correction value.
